(19) United States
(12) Patent Application Publication
(10) Pub. No.: US 2003/0191250 A1
(43) Pub. Date: Oct. 9, 2003

(54) Impact-modified polymer composition

(76) Inventors: Andreas Seidel, Dormagen (DE); Thomas Eckel, Dormagen (DE)

Correspondence Address: BAYER POLYMERS LLC, 100 BAYER ROAD, PITTSBURGH, PA, 15205, US

(21) Appl. No.: 10/395,408

(22) Filed: Mar. 24, 2003

(30) Foreign Application Priority Data
Mar. 26, 2002 (DE) 10213431.6

(51) Int. Cl. C08G 79/02

(52) U.S. Cl. 525/538

(57) ABSTRACT

A thermoplastic molding composition suitable for molding articles that feature good mechanical properties, good flowability and improved flame, heat and UV resistance is disclosed. The composition contains polycarbonate and/or polyestercarbonate, calcined talc, a graft polymer and at least one oligomeric phosphoric acid esters conforming to formula (I),

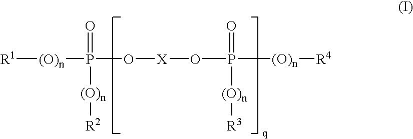

wherein

R¹, R², R³ and R⁴ independently one of the others denote C₁ to C₈ alkyl, C₅ to C₆ cycloalkyl, C₆ to C₂₀ aryl or C₇ to C₁₂ aralkyl, n independently one of the others denotes 0 or 1 q denotes 0.8 to 30 and X denotes a member selected from the group consisting of mononuclear or polynuclear aromatic radical having 6 to 30 C atoms, and linear or branched aliphatic radical having 2 to 30 C atoms.

### FIELD OF THE INVENTION

The invention concerns a thermoplastic molding composition and more especially an impact-modified polycarbonate composition.

### SUMMARY OF THE INVENTION

A thermoplastic molding composition suitable for molding articles that feature good mechanical properties, good flowability and improved flame, heat and UV resistance is disclosed. The composition contains polycarbonate and/or polyestercarbonate, calcined talc, a graft polymer and at least one oligomeric phosphoric acid esters conforming to formula (I )

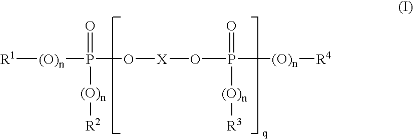

wherein

R¹, R², R³ and R⁴ independently one of the others denote C₁ to C₈ alkyl, C₅ to C₆ cycloalkyl, C₆ to C₂₀ aryl or C₇ to C₁₂ aralkyl, n independently one of the others denotes 0 or 1 q denotes 0.8 to 30 and X denotes a member selected from the group consisting of mononuclear or polynuclear aromatic radical having 6 to 30 C atoms, and linear or branched aliphatic radical having 2 to 30 C atoms.

### BACKGROUND OF THE INVENTION

It is known that talc may be added as a reinforcing material to increase the rigidity and tensile strength, to increase the dimensional stability under temperature fluctuations and to improve the surface properties of polycarbonate compositions. In flame-resistant materials the talc addition also serves as a flame proofing synergist.

WO00/148 074 describes flame-resistant and impact-modified polycarbonate compositions filled with talc. Calcined talc is not mentioned.

JP-A 0 731 6411 describes PC/ABS molding compositions that contain 1 to 30% of an aromatic monophosphate as flame retardant and 1 to 20% of a calcined talc having an average particle diameter of 2 μm or less as filler. The molding compositions are characterized by good processability, toughness and heat resistance together with excellent flame proofing. Experience teaches, however, that monophosphates have a tendency towards bleeding and the undesirable formation of plate-out when processed by injection molding.

PC/SAN blends having polystyrene-grafted polybutadiene rubber as impact modifier and containing mineral fillers, e.g. talc, are known from WO 98/51737 A1. The use of calcined talc is not described. The molding compositions described are not flame resistant.

U.S. Pat. No. 5,162,419 describes PC/ABS molding compositions containing talc having an average particle size of 1.5 to 20 μm, preferably 4.0 to 10 μm, to improve the surface appearance of injection molded parts. The molding compositions described are characterized by a matt surface and improved mechanical properties and are not flame resistant.

Flame-resistant PC/ABS compositions containing talc and phosphoric acid esters are known from JP-A 11/199768. The PC/ABS compositions described display an improved fire behaviour and are suitable in particular for thin-walled applications. Molding compositions with calcined talc grades are not described.

EP-A 0 758 003 A2 describes PC molding compositions that may contain inorganic fillers as reinforcing material. Talc inter alia is cited as filler. The PC molding compositions may also be flame resistant and are characterized by an improved surface appearance and a high modulus of elasticity. Polycarbonate blends are not described in this specification.

EP-A 0 391 413 describes PC/ABS molding compositions containing inorganic fillers having special geometric properties, whereby the molding compositions are distinguished by a low coefficient of linear and thermal expansion, high toughness under impact stress and high heat resistance. Non-calcined talc and clay materials are described as fillers according to the invention. Flame retardants are mentioned only generally in a list of additives.

The disadvantage of the talc-containing PC/ABS blends known from the prior art is that important mechanical properties such as weld line strength and toughness are decisively reduced by the addition of talc. Particularly in the case of talc grades that are not highly pure, there is also a deterioration in the inherent color of the material and in the ageing stability, particularly in the color stability of the compositions under exposure to UV light.

It is therefore desirable to provide polycarbonate compositions to which talc is added by known means for the purpose of improving at least one material property, which are characterized by an advantageous combination of weld line strength and color stability and which display excellent flame resistance.

### DETAILED DESCRIPTION OF THE INVENTION

Surprisingly it was found that impact-modified polycarbonate molding compositions containing a calcined talc and an oligomeric phosphoric acid ester as flame retardant display the desired range of properties.

The invention therefore provides polycarbonate molding compositions that contain a graft polymer and oligomeric phosphoric acid esters having the formula (I),

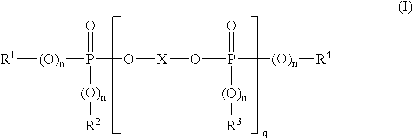

wherein

R¹, R², R³ and R⁴ each mutually independently denote optionally halogenated C₁ to C₈ alkyl, C₅ to C₆ cycloalkyl, C₆ to C₂₀ aryl or C₇ to C₁₂ aralkyl, each optionally substituted by alkyl, preferably C₁ to C₄ alkyl, and/or halogen, preferably chlorine, bromine,

n mutually independently denotes 0 or 1

q denotes 0.8 to 30 and

X denotes a mononuclear or polynuclear aromatic radical having 6 to 30 C atoms, or a linear or branched aliphatic radical having 2 to 30 C atoms, which may be OH-substituted and may contain up to 8 ether bonds,

and calcined talc.

Thermoplastic molding compositions are preferred that contain

A) 40 to 99, preferably 50 to 90 parts by weight, particularly preferably 60 to 80 parts by weight of aromatic polycarbonate and/or polyester carbonate

B) 0.5 to 60, preferably 1 to 40, particularly 2 to 25 parts by weight of graft polymer of

B.1) 5 to 95, preferably 30 to 90 wt. % of one or more vinyl monomers on

B.2) 95 to 5, preferably 70 to 10 wt. % of one or more graft bases having a glass transition temperature <10° C., preferably <0° C., particularly preferably <−20° C., the percents being relative to the weight of the graft polymer,

C) 0 to 45, preferably 0 to 30, particularly preferably 2 to 25 parts by weight of at least one thermoplastic polymer, selected from the group of vinyl (co)polymers and polyalkylene terephthalates.

D) 0.5 to 20 parts by weight, preferably 1 to 18 parts by weight, particularly preferably 2 to 16 parts by weight of oligomeric phosphoric acid esters having the aforementioned formula (I)

E) 0.2 to 20 parts by weight, preferably 0.5 to 15, particularly 0.8 to 12 parts by weight of calcined talc and

F) 0 to 5, preferably 0.1 to 1, particularly 0.1 to 0.5 parts by weight of an anti-dripping agent, preferably a fluorinated polyolefin, whereby the sum of all parts by weight equals 100.

Component A

Aromatic polycarbonates and/or aromatic polyester carbonates according to component A that are suitable according to the invention are known from the literature or may be prepared by methods known from the literature (for the preparation of aromatic polycarbonates see, for example, Schnell, “Chemistry and Physics of Polycarbonates”, Inter-science Publishers, 1964, and DE-AS 1 495 626, DE-OS 2 232 877, DE-OS 2 703 376, DE-OS 2 714 544, DE-OS 3 000 610, DE-OS 3 832 396; for the preparation of aromatic polyester carbonates e.g., DE-OS 3 077 934).

Aromatic polycarbonates are prepared for example by reacting diphenols with carbonic acid halides, preferably phosgene, and/or with aromatic dicarboxylic acid dihalides, preferably benzenedicarboxylic acid dihalides, by the interfacial polycondensation process, optionally using chain terminators, for example monophenols, and optionally using trifunctional or polyfunctional branching agents, for example triphenols or tetraphenols, or alternatively by the melt process.

Diphenols for the preparation of the aromatic polycarbonates and/or aromatic polyester carbonates are preferably those having the formula (II),

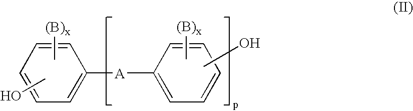

whereby

A is a single bond, C₁-C₅ alkylene, C₂-C₅ alkylidene, C₅-C₆ cycloalkylidene, —O—, —SO—, —CO—, —S—, —SO₂—, C₆-C₁₂ arylene, to which other aromatic rings optionally containing heteroatoms may be condensed,

or a radical having the formula (III) or (IV)

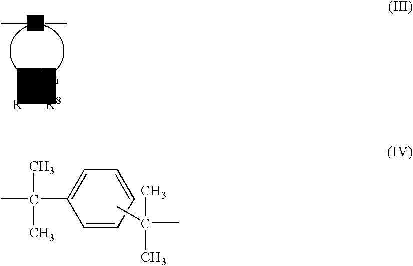

B is C₁-C₁₂ alkyl, preferably methyl, halogen, preferably chlorine and/or bromine

x is mutually independently 0, 1 or 2,

p is 1 or 0, and

R⁷ and R⁸ is individually selected for each X¹ and independently one of the other denote hydrogen or C₁-C₆ alkyl, preferably hydrogen, methyl or ethyl,

X¹ denotes carbon and

m denotes a whole number from 4 to 7, preferably 4 or 5, with the proviso that in at least one X¹ atom R⁷ and R⁸ are both alkyl

Preferred diphenols are hydroquinone, resorcinol, dihydroxy-diphenols, bis(hydroxyphenyl)-C₁-C₅-alkanes, bis(hydroxyphenyl)-C₅-C₆-cycloalkanes, bis(hydroxphenyl) ethers, bis(hydroxyphenyl) sulfoxides, bis(hydroxyphenyl) ketones, bis(hydroxyphenyl) sulfones and α,α-bis-(hydroxyphenyl) diisopropyl benzenes along with their ring-brominated and/or ring-chlorinated derivatives.

Particularly preferred diphenols are 4,4′-dihydroxydiphenyl, bisphenol A, 2,4-bis-(4-hydroxyphenyl)-2-methyl butane, 1,1-bis-(4-hydroxyphenyl) cyclohexane, 1,1-bis-(4-hydroxyphenyl-3.3.5-trimethyl cyclohexane, 4,4′-dihydroxydiphenyl sulfide, 4,4′-dihydroxydiphenyl sulfone and dibrominated and tetrabrominated or chlorinated derivatives thereof such as e.g. 2,2-bis-(3-chloro-4-hydroxyphenyl) propane, 2,2-bis-(3,5-dichloro-4-hydroxyphenyl) propane or 2,2-bis-(3,5-dibromo-4-hydroxy-phenyl) propane.

2,2-bis-(4-hydroxyphenyl) propane (bisphenol A) is especially preferred.

The diphenols may be used individually or in any mixture whatsoever.

The diphenols are known from the literature or may be obtained by methods known from the literature.

Suitable chain terminators for the preparation of the thermoplastic, aromatic polycarbonates are for example phenol, p-chlorophenol, p-tert.-butyl phenol or 2,4,6-tribromophenol, as well as long-chain alkyl phenols such as 4-(1,3-tetramethyl butyl) phenol according to DE-OS 2 842 005 or monoalkyl phenol or dialkyl phenols having a total of 8 to 20 C atoms in the alkyl substituents, such as 3,5-di-tert.-butyl phenol, p-iso-octyl phenol, p-tert.-octyl phenol, p-dodecyl phenol and 2-(3,5-dimethyl heptyl) phenol and 4-(3,5-dimethyl heptyl) phenol. The amount of chain terminators to be used is generally between 0.5 mol % and 10 mol %, relative to the molar sum of diphenols used in each case.

The thermoplastic, aromatic polycarbonates have weight-average molecular weights (M_{w}, measured e.g. by ultracentrifuge or light-scattering measurement) of 10,000 to 200,000, preferably 20,000 to 80,000.

The thermoplastic, aromatic polycarbonates may be branched by known means, and preferably by the incorporation of 0.05 to 2.0 mol %, relative to the total amount of diphenols used, of trifunctional or polyfunctional compounds, for example those having three and more phenolic groups.

Both homopolycarbonates and copolycarbonates are suitable. 1 to 25 wt. %, preferably 2.5 to 25 wt. % (relative to the total amount of diphenols to be used) of polydiorganosiloxanes having hydroxyaryloxy terminal groups may also be used in the production of copolycarbonates according to the invention as component A. These are known (see for example U.S. Pat. No. 3,419,634) or may be produced by methods known from the literature. The production of polydiorganosiloxane-containing copolycarbonates is described e.g. in DE-OS 3 334 782.

In addition to the bisphenol A homopolycarbonates, preferred polycarbonates are the copolycarbonates of bisphenol A having up to 15 mol %, relative to the molar sums of diphenols, of other diphenols cited as being preferred or particularly preferred, in particular 2,2-bis-(3,5-dibromo-4-hydroxyphenyl) propane.

Aromatic dicarboxylic acid dihalides for the production of aromatic polyester carbonates are preferably the di-acid dichlorides of isophthalic acid, terephthalic acid, diphenyl ether-4,4′-dicarboxylic acid and naphthaline-2,6-dicarboxylic acid.

Mixtures of the di-acid dichlorides of isophthalic acid and terephthalic acid in a ratio between 1:20 and 20:1 are particularly preferred.

In the production of polyester carbonates a carbonic acid halide, preferably phosgene, is also incorporated as a bifunctional acid derivative.

Examples of chain terminators for the production of aromatic polyester carbonates also include, in addition to the monophenols already cited, chloroformic acid esters thereof and the. acid chlorides of aromatic monocarboxylic acids, which may optionally be substituted by C₁-C₂₂ alkyl groups or by halogen atoms, along with aliphatic C₂-C₂₂ monocarboxylic acid chlorides.

The quantity of chain terminators in each case is 0.1 to 10 mol %, relative to moles of diphenols in the case of phenolic chain terminators and to moles of dicarboxylic acid dichlorides in the case of monocarboxylic acid chloride chain terminators.

The aromatic polyester carbonates may also contain incorporated aromatic hydroxycarboxylic acids.

The aromatic polyester carbonates may be both linear and branched by known means (see also DE-OS 2 940 024 and DE-OS 3 007 934 in this connection).

Examples of branching agents that may be used include trifunctional or polyfunctional carboxylic acid chlorides, such as trimesic acid trichloride, cyanuric acid trichloride, 3,3′-4,4′-benzophenone tetracarboxylic acid tetrachloride, 1,4,5,8-naphthaline tetracarboxylic acid tetrachloride or pyromellitic acid tetrachloride, in quantities of 0.01 to 1.0 mol % (relative to dicarboxylic acid dichlorides used) or trifunctional or polyfunctional phenols, such as phloroglucinol, 4,6-dimethyl-2,4,6-tri-(4-hydroxyphenyl) heptene-2,4,4-dimethyl-2,4,6-tri-(4-hydroxyphenyl) heptane, 1,3,5-tri-(4-hydroxyphenyl) benzene, 1,1,1-tri-(4-hydroxyphenyl) ethane, tri-(4-hydroxyphenyl) phenyl methane, 2,2-bis-[4,4-bis-(4-hydroxy-phenyl) cyclohexyl]propane, 2,4-bis-(4-hydroxyphenyl isopropyl) phenol, tetra-(4-hydroxyphenyl) methane, 2,6-bis-(2-hydroxy-5-methylbenzyl)-4-methyl phenol, 2-(4-hydroxyphenyl)-2-(2,4-dihydroxyphenyl) propane, tetra-(4-[4-hydroxyphenyl isopropyl]phenoxy) methane,1,4-bis-[4,4′-dihydroxytriphenyl) methyl]benzene, in quantities of 0.01 to 1.0 mol %, relative to diphenols used. Phenolic branching agents may be included with the diphenols, acid chloride branching agents may be introduced together with the acid dichlorides.

The proportion of carbonate structural units in the thermoplastic, aromatic polyester carbonates may vary widely. The proportion of carbonate groups is preferably up to 100 mol %, in particular up to 80 mol %, particularly preferably up to 50 mol %, relative to the sum of ester groups and carbonate groups. Both the ester and the carbonate component of the aromatic polyester carbonates may be in the form of blocks or randomly distributed in the polycondensate.

The relative solution viscosity (ηᵣₑₗ) of the aromatic polycarbonates and polyester carbonates is in the range from 1.18 to 1.4, preferably 1.22 to 1.3 (measured in solutions of 0.5 g polycarbonate or polyester carbonate in 100 ml methylene chloride solution at 25° C.).

The thermoplastic, aromatic polycarbonates and polyester carbonates may be used alone or in any mixture with one another.

Component B

Component B comprises one or more graft polymers of

B.1 5 to 95, preferably 30 to 90 wt. %, of at least one vinyl monomer on

B.2 95 to 5, preferably 70 to 10 wt. %, or one or more graft bases having glass transition temperatures <10° C., preferably <0° C., particularly preferably <−20° C., the percents being relative to the weight of the graft polymer .

The graft base B.2 generally has an average particle size (d₅₀ value) of 0.05 to 5 μm, preferably 0.10 to 2 μm, particularly preferably 0.20 to 1 μm, in particular 0.2 to 0.5 μm.

Monomers B.1 are preferably mixtures of

B.1.1 50 to 99 parts by weight of vinyl aromatics and/or ring-substituted vinyl aromatics (such as e.g. styrene, (α-methyl styrene, p-methyl styrene, p-chlorostyrene) and/or (meth)acrylic acid (C₁-C₈) alkyl esters (such as e.g. methyl methacrylate, ethyl, methacrylate) and

B.1.2 1 to 50 parts by weight of vinyl cyanides (unsaturated nitriles such as acrylonitrile and methacrylonitrile) and/or (meth)acrylic acid (C₁-C₈) alkyl esters (such as e.g. methyl methacrylate, n-butyl acrylate, t-butyl acrylate) and/or derivatives (such as anhydrides and imides) of unsaturated carboxylic acids (for example maleic anhydride and N-phenyl maleinimide).

Preferred monomers B.1.1 are at least one of the monomers selected from the group consisting of styrene, α-methyl styrene and methyl methacrylate, preferred monomers B.1.2 are at least one of the monomers selected from the group consisting of acrylonitrile, maleic anhydride and methyl methacrylate.

Particularly preferred monomers are B.1.1 styrene and B.1.2 acrylonitrile.

Suitable graft bases B.2 for the graft polymers B are for example diene rubbers, EP(D)M rubbers, i.e. those based on ethylene/propylene and optionally diene, acrylate, polyurethane, silicone, chloroprene and ethylene/vinyl acetate rubbers.

Preferred graft bases B.2 are diene rubbers (e.g. based on butadiene, isoprene, etc.) or mixtures of diene rubbers or copolymers of diene rubbers or mixtures thereof with other copolymerizable monomers (e.g. according to B.1.1 and B.1.2), preferably butadiene-styrene copolymers, with the proviso that the glass transition temperature of component B.2 is below <10° C., preferably <0° C., particularly preferably <−10° C.

Pure polybutadiene rubber is particularly preferred.

Particularly preferred polymers B are e.g. ABS polymers (emulsion, bulk and suspension ABS), such as are described e.g., in DE-OS 2 035 390 (=U.S. Pat No. 3,644,574) or in DE-OS 2 248 242 (=GB-PS 1 409 275) or in Ullmann, Enzyklopädie der Technischen Chemie, Vol. 19 (1980), p. 280 ff. The gel component of graft base B.2 is at least 30 wt. %, preferably at least 40 wt. % (measured in toluene).

The graft copolymers B are produced by radical polymerization, e.g., by emulsion, suspension, solution or bulk polymerization, preferably by emulsion polymerization or bulk polymerization.

Particularly suitable graft rubbers are also ABS polymers produced by redox initiation with an initiator system of organic hydroperoxide and ascorbic acid according to U.S. Pat. No. 4,937,285.

Since it is known that the graft monomers are not necessarily completely grafted onto the graft base during the graft reaction, graft polymers B according to the invention also refer to such products that are obtained by (co)polymerization of the graft monomers in the presence of the graft base and that co-accumulate during preparation.

Suitable acrylate rubbers according to B.2 for the polymers B are preferably polymers of acrylic acid alkyl esters, optionally with up to 40 wt. %, relative to B.2, of other polymerizable, ethylenically unsaturated monomers. The preferred polymerizable acrylic acid esters include C₁-C₈ alkyl esters, for example methyl, ethyl, butyl, n-octyl and 2-ethylhexyl ester; haloalkyl esters, preferably halogen C₁-C₈ alkyl esters, such as chloroethyl acrylate, and mixtures of these monomers.

Monomers having more than one polymerizable double bond may be copolymerized for crosslinking. Preferred examples of crosslinking monomers are esters of unsaturated monocarboxylic acids with 3 to 8 C atoms and unsaturated monohydric alcohols with 3 to 12 C atoms, or saturated polyols with 2 to 4 OH groups and 2 to 20 C atoms, such as e.g., ethylene glycol dimethacrylate, allyl methacrylate; polyunsaturated heterocyclic compounds, such as e.g. trivinyl and triallyl cyanurate; polyfunctional vinyl compounds, such as divinyl and trivinyl benzenes; but also triallyl phosphate and diallyl phthalate.

Preferred crosslinking monomers are allyl methacrylate, ethylene glycol dimethacrylate, diallyl phthalate and heterocyclic compounds displaying at least 3 ethylenically unsaturated groups.

Particularly preferred crosslinking monomers are the cyclic monomers triallyl cyanurate, triallyl isocyanurate, triacryloyl hexahydro-s-triazine, triallyl benzenes. The quantity of crosslinking monomers is preferably 0.02 to 5, particularly 0.05 to 2 wt. %, relative to the graft base B.2.

In the case of cyclic crosslinking monomers with at least 3 ethylenically unsaturated groups it is advantageous to restrict the quantity to below 1 wt. % of the graft base B.2.

Preferred “other” polymerizable, ethylenically unsaturated monomers which may optionally serve to produce the graft base B.2 in addition to the acrylic acid esters are e.g. acrylonitrile, styrene, α-methyl styrene, acrylamides, vinyl C₁-C₆ alkyl ethers, methyl methacrylate, butadiene. Preferred acrylate rubbers as graft base B.2 are emulsion polymers displaying a gel content of at least 60 wt. %.

Other suitable graft bases according to B.2 are silicone rubbers with graft-active sites, such as are described in DE-OS 3 704 657, DE-OS 3 704 655, DE-OS 3 631 540 and DE--OS 3 631 539.

The gel content of graft base B.2 is determined at 25° C. in a suitable solvent (M. Hoffmann, H. Krömer, R. Kuhn, Polymeranalytik I and II, Georg Thieme-Verlag, Stuttgart 1977).

The average particle size d₅₀ is the diameter above and below which respectively 50 wt. % of the particles lie. It may be determined by ultracentrifuge measurement (W. Scholtan, H. Lange, Kolloid, Z. und Z. Polymere 250 (1972), 782-1796).

Component C

Component C includes one or more thermoplastic vinyl (co)polymers C.1 and/or polyalkylene terephthalates C.2 .

Suitable vinyl (co)polymers C.1 are polymers of at least one monomer from the group of vinyl aromatics, vinyl cyanides (unsaturated nitriles), (meth)acrylic acid C₁-C₈ alkyl esters, unsaturated carboxylic acids and derivatives (such as anhydrides and imides) of unsaturated carboxylic acids. Particularly suitable are (co)polymers consisting of

C.1.1 50 to 99, preferably 60 to 80 parts by weight of vinyl aromatics and/or ring-substituted vinyl aromatics, such as e.g. styrene,(α-methyl styrene, p-methyl styrene, p-chlorostyrene), and/or (meth)acrylic acid (C₁-C₈) alkyl esters, such as e.g. methyl methacrylate, ethyl methacrylate), and

C.1.2 1 to 50, preferably 20 to 40, parts by weight of vinyl cyanides (unsaturated nitriles), such as acrylonitrile and methacrylonitrile and/or (meth)acrylic acid (C₁-C₈) alkyl esters (such as e.g. methyl methacrylate, n-butyl acrylate, t-butyl acrylate) and/or unsaturated carboxylic acids (such as maleic acid) and/or derivatives (such as anhydrides and imides) of unsaturated carboxylic acids (for example maleic anhydride and N-phenyl maleinimide).

The (co)polymers C.1 are resinous, thermoplastic and rubber-free.

The copolymer of C.1.1 styrene and C.1.2 acrylonitrile is particularly preferred.

The (co)polymers according to C.1 are known and may be produced by radical polymerization, in particular by emulsion, suspension, solution or bulk polymerization. The (co)polymers preferably have molecular weights \overline{M}w (weight average, determined by light scattering or sedimentation) of 15,000 and 200,000.

The polyalkylene terephthalates in component C.2 are reaction products of aromatic dicarboxylic acids or reactive derivatives thereof, such as dimethyl esters or anhydrides, and aliphatic, cycloaliphatic or araliphatic diols and mixtures of these reaction products.

Preferred polyalkylene terephthalates contain at least 80 wt. %, preferably at least 90 wt. %, relative to the dicarboxylic acid component, of terephthalic acid radicals and at least 80 wt. %, preferably at least 90 mol %, relative to the diol component, of ethylene glycol and/or butanediol-1,4 radicals.

In addition to terephthalic acid radicals, the preferred polyalkylene terephthalates may contain up to 20 mol %, preferably up to 10 mol %, of radicals of other aromatic or cycloaliphatic dicarboxylic acids with 8 to 14 C atoms or aliphatic dicarboxylic acids with 4 to 12 C atoms, such as e.g., radicals of phthalic acid, isophthalic acid, naphthaline-2,6-dicarboxylic acid, 4,4′-diphenyl dicarboxylic acid, succinic acid, adipic acid, sebacic acid, azelaic acid, cyclohexane diacetic acid.

In addition to ethylene glycol or butanediol-1,4 radicals, the preferred polyalkylene terephthalates may contain up to 20 mol %, preferably up to 10 mol %, of other aliphatic diols with 3 to 12 C atoms or cycloaliphatic diols with 6 to 21 C atoms, e.g. radicals of propanediol-1,3,-2-ethyl propanediol-1,3, neopentyl glycol, pentanediol-1,5, hexanediol-1,6, cyclohexane dimethanol-1,4, 3-ethyl pentanediol-2,4, 2-methyl pentane-ediol-2,4, 2,2,4-trimethyl pentanediol-1,3, 2-ethyl hexanediol-1,3, 2,2-diethyl propanediol-1,3, hexanediol-2,5, 1,4-di-(β-hydroxyethoxy)benzene, 2,2-bis-(4-hydroxycyclohexyl) propane, 2,4-dihydroxy-1,1,3,3-tetramethyl cyclobutane, 2,2-bis-(4-β-hydroxyethoxyphenyl) propane and 2,2-bis-(4-hydroxypropoxyphenyl) propane (DE-OS 2 407 674, 2 407 776, 2 715 932).

The polyalkylene terephthalates may be branched by incorporating relatively small amounts of trihydric or tetrahydric alcohols or tribasic or tetrabasic carboxylic acids, e.g. according to DE-OS 1 900 270 and U.S. Pat. No. 3,692,744. Examples of preferred branching agents are trimesic acid, trimellitic acid, trimethylol ethane and propane and pentaerythritol.

Polyalkylene terephthalates produced solely from terephthalic acid and reactive derivatives thereof (e.g., dialkyl esters thereof) and ethylene glycol and/or butanediol-1,4, and mixtures of these polyalkylene terephthalates, are particularly preferred.

Mixtures of polyalkylene terephthalates contain 1 to 50 wt. %, preferably 1 to 30 wt. %, of polyethylene terephthalate and 50 to 99 wt. %, preferably 70 to 99 wt. %, of polybutylene terephthalate.

The polyalkylene terephthalates that are preferably used generally have an intrinsic viscosity of 0.4 to 1.5 dl/g, preferably 0.5 to 1.2 dl/g, measured in phenol/o-dichlorobenzene (1:1 parts by weight) at 25° C. in an Ubbelohde viscometer.

The polyalkylene terephthalates may be produced by known methods (see e.g. Kunststoff-Handbuch, Volume VIII, page 695 ff., Carl-Hanser-Verlag, Munich 1973).

Component D

The compositions according to the invention contain as flame retardants oligomeric phosphoric acid esters having the general formula (I),

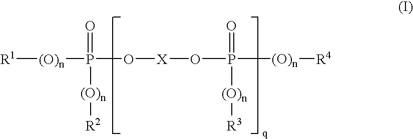

in which the radicals have the meanings cited above.

R¹, R², R³ and R⁴ preferably mutually independently stand for C₁ to C₄ alkyl, phenyl, naphthyl or phenyl C₁-C₄ alkyl. The aromatic groups R¹, R², R³ and R⁴ may be substituted for their part with halogen and/or alkyl groups, preferably chlorine, bromine and/or C₁ to C₄ alkyl. Particularly: preferred aryl radicals are cresyl, phenyl, xylenyl, propyl phenyl or butyl phenyl and the corresponding brominated and chlorinated derivatives thereof.

X in formula (I) preferably denotes a mononuclear or polynuclear aromatic radical with 6 to 30 C atoms preferably deriveed from diphenols conforming to formula (II).

n in formula (I) may mutually independently be 0 or 1, n preferably equals 1.

q stands for values from 0.8 to 30. If mixtures of different components of formula (I) are used, mixtures preferably having number-averaged q values of 0.8 to 20, particularly preferably 0.9 to 10, in particular 1 to 3, may be used.

X particularly preferably stands for

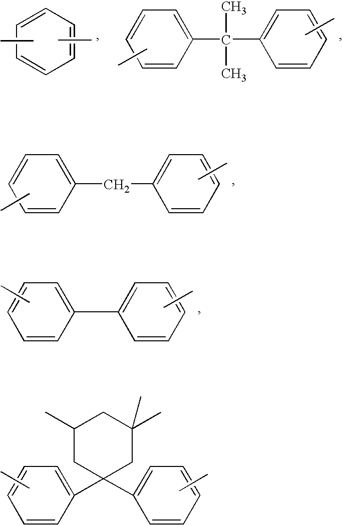

or chlorinated or brominated derivatives thereof, in particular X is derived from resorcinol, hydroquinone, bisphenol A or diphenyl phenol. X particularly preferably is derived from bisphenol A.

The use of oligomeric phosphoric acid esters having formula (I) derived from bisphenol A (cf. formula (Ia)) is particularly advantageous, since compositions containing this phosphorus compound display a particularly high stress cracking resistance and hydrolysis resistance and a particularly low tendency towards plate-out when processed by injection molding. Furthermore, a particularly high heat resistance may be achieved with these flame retardants.

Particularly preferred phosphorus-containing compounds are compounds having the formula (Ia),

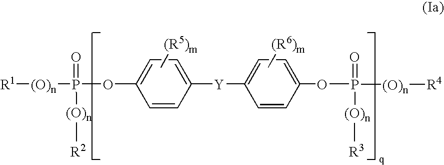

whereby

R¹, R², R³, R⁴, n and q have the meaning cited for formula (I),

m mutually independently denotes 0, 1, 2, 3 or 4,

R⁵ and R⁶ mutually independently denote C₁ to C₄ alkyl, preferably methyl or ethyl and

Y denotes C₁, to C₇ alkylidene, C₁-C₇ alkylene, C₅ to C₁₂ cycloalkylene, C₅ to C₁₂cycloalkylidene, —O—, —S—, —SO₂ or—CO—, preferably isopropylidene or methylene.

The phosphorus compounds according to component E are known (cf. e.g. EP-A 0 363 608, EP-A 0 640 655) or may be produced by known methods (e.g. Ullmanns Enzyklopädie der technischen Chemie, Vol. 18, p. 301 ff. 1979; Houben-Weyl, Methoden der organischen Chemie, Vol. 12/1, p. 43; Beilstein, Vol. 6, p. 177).

The average q values may be determined by determining the composition of the phosphate mixture (molecular weight distribution) by a suitable method (gas chromatography (GC), high-pressure liquid chromatography (HPLC), gel permeation chromatography (GPC)) and using it to calculate the average values for q.

Component E

The compositions according to the invention contain calcined talc. This may be obtained by the calcination of talc, i.e. thermal treatment at high temperatures, preferably at temperatures >1000° C., by known means. Above 900° C., talc progressively loses its hydroxyl groups and, above 1050° C., it recrystallizes to form enstatite, an anhydrous magnesium silicate of formula

Mg₂[Si₂O₆].

Calcined talc according to the present invention therefore contains at least one of an enstatite and a dehydroxalized talc. The calcined talc may be surface treated, e.g. silanised, to improve the contact with the polymer. Calcined talc is commercially available, e.g. from Nippon Talc K. K., Japan, or Hayaslie Kasei K. K., Japan.

Component F

The flame retardants according to component D are often used in combination with anti-dripping agents, which reduce the tendency of the material to form burning drips in the event of a fire. Compounds from the substance classes of fluorinated polyolefins, silicones and aramid fibres may be cited here by way of example. These may also be used in the compositions according to the invention. Fluorinated polyolefins are preferably used as anti-dripping agents.

Fluorinated polyolefins are known and described for example in EP-A 0 640 655. They are sold by DuPont, for example, under the brand name Teflon® 30N.

The fluorinated polyolefins may be used both in pure form and in the form of a coagulated mixture of emulsions of the fluorinated polyolefins with emulsions of the graft polymers (component B) or with an emulsion of a copolymer, preferably on a styrene/acrylonitrile basis, whereby the fluorinated polyolefin is mixed as an emulsion with an emulsion of the graft polymer or copolymer and then coagulated.

The fluorinated polyolefins may further be used as a pre-compound with the graft polymer (component B) or a copolymer, preferably on a styrene/acrylonitrile basis. The fluorinated polyolefins are mixed as a powder with a powder or pellets of the graft polymer or copolymer and compounded in the melt, generally at temperatures of 200 to 330° C., in conventional units such as internal mixers, extruders or twin screws.

The fluorinated polyolefins may also be used in the form of a masterbatch, which is produced by emulsion polymerization of at least one monoethylenically unsaturated monomer in the presence of an aqueous dispersion of the fluorinated polyolefin. Preferred monomer components are styrene, acrylonitrile and mixtures thereof. The polymer is used as a free-flowing powder after acid precipitation and subsequent drying.

The coagulates, pre-compounds or masterbatches conventionally have solids contents of 5 to 95 wt. %, preferably 7 to 60 wt. %, of fluorinated polyolefin.

The stated quantities of fluorinated polyolefins relate to the absolute quantity of fluorinated polyolefin.

Component G (other additives)

The compositions according to the invention may also contain at least one of the conventional additives, such as lubricants and release agents, for example pentaerythritol tetrastearate, nucleating agents, antistatics, stabilisers, and other fillers and reinforcing agents along with dyes and pigments.

The compositions according to the invention may contain up to 35 wt. %, relative to the overall composition, of an additional, optionally synergistically acting flame retardant. Examples of additional flame retardants that may be cited are silicones, organic halogen compounds such as decabromobisphenyl ether, tetrabromobisphenol, inorganic halogen compounds such as ammonium bromide, nitrogen compounds, such as melamine, melamine-formaldehyde resins, inorganic hydroxide compounds such as Mg, Al hydroxide, inorganic compounds such as antimony oxides, barium metaborate, hydroxoantimonate, zirconium oxide, zirconium hydroxide, molybdenum oxide, ammonium molybdate, zinc borate, ammonium borate, barium metaborate, talc, silicate, silicon oxide and tin oxide, as well as siloxane compounds.

The sum of the percentages by weight of all components equals 100.

The compositions according to the invention are produced by mixing the various constituents by known means and melt compounding and melt extruding them at temperatures of 200° C. to 300° C. in conventional units such as internal mixers, extruders and twin screws.

The individual constituents may be mixed by known means both successively and simultaneously, both at around 20° C. (room temperature) and at elevated temperature.

The compositions according to the invention may be used in the production of all types of moldings. These may be produced for example by injection molding, extrusion and blow molding processes. A further form of processing is the production of moldings by thermoforming from prefabricated sheets or films.

Examples of such moldings are films, profiles, all types of housing sections, e.g. for domestic appliances such as juice extractors, coffee machines, mixers; for office equipment such as monitors, printers, copiers; also plates, pipes, electric wiring ducts, profiles for the construction sector, interior fittings and exterior applications; parts for the electrical engineering sector such as switches and plugs and interior and exterior automotive parts.

The compositions according to the invention may in particular be used to produce the following moldings or molded parts, for example:

Interior fittings for rail vehicles, ships, aircraft, buses and cars, hub caps, housings for electrical appliances containing miniature transformers, housings for equipment for information dissemination and transfer, housings and cladding for medical purposes, massage equipment and housings, toy vehicles for children, two-dimensional prefabricated wall panels, housings for safety equipment, rear spoilers, automotive body parts, heat-insulated transport containers, equipment for handling or caring for small animals, molded parts for sanitary and bathroom equipment, covering grid plates for ventilator openings, molded parts for garden sheds and tool sheds, housings for gardening implements.

The following examples are intended to illustrate the invention in more detail.

### EXAMPLES

The components set out in Table 1 and briefly described below are compounded on a ZSK-25 at 240° C. The moldings are produced on an Arburg 270 E injection molding machine at 240° C.

Component A

Linear polycarbonate based on bisphenol A with a relative solution viscosity of 1.24, measured in CH₂Cl₂ as solvent at 25° C. and in a concentration of 0.5 g/100 ml.

Component B

Graft polymer of 40 parts by weight of a copolymer of styrene and acrylonitrile in the ratio 73:27 on 60 parts by weight of particulate crosslinked polybutadiene rubber ( mean particle diameter d₅₀=0.3 μm), produced by emulsion polymerization.

Component C

Styrene/acrylonitrile copolymer with a ratio of styrene to acrylonitrile of 72:28 and an intrinsic viscosity of 0.55 dl/g (Measurement in dimethyl formamide at 20° C.).

Component D

Phosphate based on bisphenol A

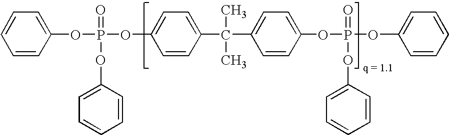

In order to determine the average q value, the contents of oligomeric phosphates were first determined by HPLC measurements:

Column type: LiChrosorp RP-8

Eluent in gradient: acetonitrile/water 50:50 to 100:0

Concentration: 5 mg/ml

The number-weighted average values were then calculated from the contents of the individual components (monophosphates and oligophosphates) by known methods.

Component E1

Chlorite talc with a chlorite content of 20 wt. % and a mean particle diameter d₅₀=2.0 μm.

Component E2

Calcined talc (produced from E1 by calcination at 1000° C.).

Component F

Tetrafluoroethylene polymer as a coagulated mixture of a graft polymer emulsion according to the aforementioned component B in water and a tetrafluoroethylene polymer emulsion in water. The ratio by weight of graft polymer B to the tetrafluoroethylene polymer in the mixture is 90 wt. % to 10 wt. %. The tetrafluoroethylene polymer emulsion has a solids content of 60 wt. %; the average particle diameter is between 0.05 and 0.5 μm. The graft polymer emulsion has a solids content of 34 wt. %.

The emulsion of the tetrafluoroethylene polymer (Teflon® 30 N from DuPont) is mixed with the emulsion of the graft polymer B and stabilised with 1.8 wt. %, relative to polymer solids, of phenolic antioxidants. The mixture is coagulated with an aqueous solution of MgSO₄ (Epsom salts) and acetic acid at pH 4 to 5 and at a temperature of 85 to 95° C., filtered and washed until it is practically free from electrolytes, then freed from the bulk of the water by centrifuging and subsequently dried to a powder at 100° C.

Component G1

Pentaerythritol tetrastearate (PETS) as release agent.

Component G2

Phosphite stabiliser

Neither G1 nor G2 are believed critical to the findings giving rise to the present invention.

Testing the Properties of the Molding Compositions According to the Invention

The impact strength aₙ is determined in accordance with ISO 180/1 U.

To determine the weld line strength, the impact strength is measured at the weld line of specimens gated on both sides and measuring 170×10×4 mm in accordance with ISO 179/1eU.

The fire behaviour of the flame resistant specimens was measured on test pieces measuring 127×12.7×0.8 mm in accordance with UL-Subj. 94 V.

The Vicat B heat resistance is determined in accordance with ISO 306 on test pieces measuring 80×10×4 mm.

The melt viscosity is determined in accordance with DIN 54 811 at a shear rate of 1000 s⁻¹ and a temperature of 260° C.

The color stability is determined in accordance with ASTM D 4459, whereby sheets of the material are exposed to a defined UV irradiation for a total of 300 h and the chromaticity changes delta E relative to the initial value are determined after exposure times of 150 h and 300 h by spectral photometry.

TABLE 1
Molding compositions and their properties

| | 1 (comparison) | 2 |
|---|---|---|
| Components [parts by weight] | | |
| A (PC) | 63.2 | 63.2 |
| B (graft) | 4.9 | 4.9 |
| C (SAN) | 4.9 | 4.9 |
| D (BDP) | 12.8 | 12.8 |
| E1 (talc) | 9.8 | — |
| E2 (calcined talc) | — | 9.8 |
| F (PTFE masterbatch) | 3.9 | 3.9 |
| G1 (PETS) | 0.4 | 0.4 |
| G2 (stabiliser) | 0.1 | 0.1 |
| Properties | | |
| Weld line strength [kJ/m²] | 3.7 | 6.8 |
| Color stability: | | |
| delta E (150 h) | 2.1 | 1.2 |
| delta E (300 h) | 4.1 | 2.9 |
| Viscosity (260° C./1000 s⁻¹) [Pas] | 150 | 151 |
| Vicat B 120 | 100 | 100 |
| aₙ [kJ/m²] | 52 | 65 |
| UL 94 V 0.8 mm | V-O | V-O |
| Burning time | 38 s | 18 s |

The table shows that calcined talc may be used in combination with oligomeric phosphoric acid esters as FR additive to obtain PC/ABS molding compositions that are characterized by improved mechanical properties (toughness and weld line strength) and improved UV resistance with excellent flame resistance, flowability and heat resistance.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A thermoplastic molding composition comprising polycarbonate and/or polyestercarbonate, a graft polymer and at least one oligomeric phosphoric acid esters conforming to formula (I), 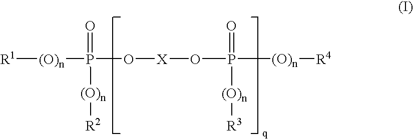
wherein
R¹, R², R³ and R⁴ independently one of the others denote C₁ to C₈ alkyl, C₅ to C₆ cycloalkyl, C₆ to C₂₀ aryl or C₇ to C₁₂ aralkyl,
n independently one of the others denotes 0 or 1
q denotes 0.8 to 30 and
X denotes a member selected from the group consisting of mononuclear or polynuclear aromatic radical having 6 to 30 C atoms, and linear or branched aliphatic radical having 2 to 30 C atoms,
and calcined talc.

2. The composition according to claim 1 containing
A) 40 to 99 parts by weight of aromatic polycarbonate and/or polyester carbonate
B) 0.5 to 60 parts by weight of graft polymer of
B.1) 5 to 95 wt. % of one or more vinyl monomers on
B.2) 95 to 5 wt. % of one or more graft bases having a glass transition temperature <10° C., said percents both occurrences being relative to the weight of the graft polymer,
C) 0 to 45 parts by weight of at least one thermoplastic polymer, selected from the group of vinyl (co)polymers and polyalkylene terephthalates.
D) 0.5 to 20 parts by weight of the oligomeric phosphoric acid esters
E) 0.2 to 20parts by weight of calcined talc and
F) 0 to 5 parts by weight of an anti-dripping agent,
whereby the sum of all- parts by weight equals 100.

3. The composition according to claim 1, wherein q in formula (I) denotes 0.8 to 20.

4. The composition according to claim 3, wherein q stands for 0.9 to 10.

5. The composition according to claim 4, wherein q stands for 1 to 3.

6. The composition according to claim 1, wherein X in formula (I) stands for a member selected from the group consisting of 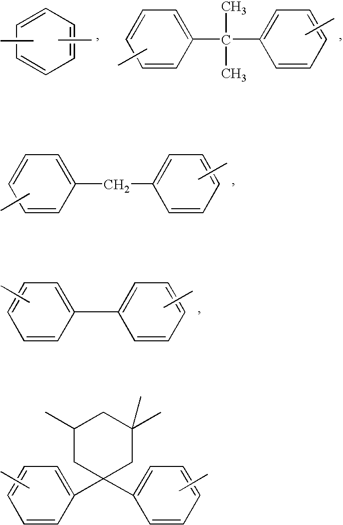
and chlorinated or brominated derivatives thereof,

7. The composition according to claim 6, wherein X is derived from resorcinol, hydroquinone or bisphenol A.

8. The composition according to claim 2 containing 50 to 90 parts by Weight of A), 1 to 40 parts by weight of B), 0 to 30 parts by weight of C), 1 to 18 parts by weight of D), 0.5 to 15 parts by weight of calcined talc and 0.1 to 1 parts by weight of F), wherein the sum of all parts by weight equals 100.

9. The composition according to claim 2, wherein component B.1 is a mixture of
B.1.1 50 to 99 wt. % of at least one monomer selected from the group consisting of vinyl aromatics, ring-substituted vinyl aromatics and (meth)acrylic acid (C₁-C₈) alkyl esters and
B.1.2 1 to 50 wt. % of at least one monomer selected from the group consisting of vinyl cyanides, (meth)acrylic acid (C₁-C₈)
alkyl esters and derivatives of unsaturated carboxylic acids, where the percents, both occurrences relate to the weight of the mixture.

10. The composition according to claim 9, wherein B.1.1 is at least one member selected from the group consisting of styrene, α-methyl styrene and methyl methacrylate and B.1.2 is at least one member selected from the group consisting of acrylonitrile, maleic anhydride and methyl methacrylate.

11. The composition according to claim 2, wherein graft base B.2 is at least one member selected from the group consisting of diene rubbers, EP(D)M rubbers, acrylate, polyurethane, silicone, chloroprene and ethylene/vinyl acetate rubbers.

12. The composition according to claim 11, wherein the graft base B.2 is at least one member selected from the group consisting of diene rubbers, butadiene/styrene copolymers and acrylate rubbers.

13. The composition according to claim 2, wherein vinyl (co)polymer C) is at least one member selected from the group consisting of vinyl aromatics, vinyl cyanides, (meth)acrylic acid (C₁-C₈) alkyl esters, unsaturated carboxylic acids and derivatives of unsaturated carboxylic acids.

14. The composition according to claim 2, wherein component E) is a fluorinated polyolefin.

15. The composition according to claim 1, further containing at least one member selected from the group consisting of lubricants, release agents, nucleating agents, antistatics, stabilizers, fillers other than calcined talc, reinforcing agents, dyes and pigments.

16. A molded article comprising the composition according to claim 1.
